(19) United States
(12) Patent Application Publication
(10) Pub. No.: US 2021/0361500 A1
(43) Pub. Date: Nov. 25, 2021

(54) A FOLDING WHEELCHAIR WITH AN EXCRETION DEVICE

(71) Applicants: CHENG-PIAO LAI, TAOYUAN CITY (TW); TING-YU LAI, TAOYUAN CITY (TW)

(72) Inventors: CHENG-PIAO LAI, TAOYUAN CITY (TW); TING-YU LAI, TAOYUAN CITY (TW)

(21) Appl. No.: 16/630,535

(22) PCT Filed: Apr. 8, 2018
(86) PCT No.: PCT/CN2018/000128

§ 371 Date: Jan. 13, 2020

(30) Foreign Application Priority Data
Jan. 24, 2018 (CN) 201810067692.X

(51) Int. Cl. A61G 5/10; A61G 5/08

(52) U.S. Cl. CPC A61G 5/1002; A61G 5/0816

(57) ABSTRACT

A folding wheelchair with an excretion device has a foldable chair frame, a supporting device on the chair frame under a seat which is also foldable together with the chair frame, a wash device for cleansing and a wipe device for wiping. The folding wheelchair allows its user to perform excretion and cleansing by himself without leaving the wheelchair, saving the self-esteem for the users and reducing the burdens for the caregivers.

### BACKGROUND OF THE INVENTION

### 1. Field of the Invention

The present invention relates to a folding wheelchair, particularly to one that has an excretion device installed thereon for its user to perform excretion while sitting on the wheelchair.

### 2. Description of the Related Art

As senior population increasing rapidly, wheelchairs have gained more attention in our society. Wheelchairs are not only needed for the disabled and wounded, but also for elders who need extra help and support in daily life. Therefore, various kinds of wheelchairs are developed to satisfied different needs for the users.

FIG. 1 shows a commonly known folding wheelchair 10 in the field. Considering easy carrying and convenient storage, the folding wheelchair 10 basically has a symmetrical chair frame 11 with a cross brace 12. Two wheels 13 are symmetrically arranged aside the chair frame 11 and two casters 14 are symmetrically arranged in a lower front of the chair frame 11. A seat 15 is disposed in-between the chair frame 11. Two symmetrical back frames 16 and two push handles 17 are extended upwardly from the chair frame 11. Between the back frames 16 there is a backrest 16 disposed. Such design makes the wheelchair portable and enables its users to carry it with them. However, when the users have the need for excretion, they have to move themselves to the toilets—in some cases, their caregivers have to do the job, which requires a great effort. The problem is even worse when the user is seriously disabled or badly injured.

FIGS. 2A and 2B display a foldable wheelchair 10A with urination and defecation functions. Such wheelchair has a different structure from the one disclosed above in that the foldable wheelchair 10A has a chair frame 120 assembled to a cross brace 121 and a seat 130 disposed on the chair frame 120, and that a container 140 is disposed under the chair frame 120 for its users to excrete thereon. However, such design has to remove the seat 130 and the container 140 before folding up the wheelchair 10A, causing more inconveniences. On the other hand, the seat 130 has an opening 131 arranged at the center thereof for excretion. If the users have to sit on the wheelchair 10A for a long period other than excreting, it is obviously uncomfortable.

Also, the armrests 150 of the conventional wheelchair 10A are fixed and cannot be moved or even lifted, which is inconvenient for the users to sit on or get up from the wheelchair. In addition, those with container or toilet tub disposed under the seat cannot allow the users to further cleanse themselves after excretion without moving or standing up, which make it impossible for the users to go through the process without extra help. There are various wheelchairs with similar functions as stated above in the markets, but the problems described still remain.

### SUMMARY OF THE INVENTION

A primary objective of the present invention is to provide a folding wheelchair with an excretion device that enables its users to perform excretion directly while sitting thereon in addition to its original functions as a foldable wheelchair.

Another objective of the present invention is to provide a folding wheelchair with an excretion device that enables its users to further cleanse themselves after excretion right on the wheelchair without moving or standing.

Yet another objective of the present invention is to provide a folding wheelchair with an excretion device that can lift the armrests thereof upwards for its users sit on or leave the wheelchair.

To achieve the object, the present invention includes a foldable chair frame including two push handles symmetrically arranged at a rear thereof and two armrests symmetrically arranged at lateral sides thereof; a cross brace including a plurality of crossed members connected to the chair frame for stable folding and unfolding; a foldable seat disposed in-between the chair frame with an opening hole arranged at a center thereof in accordance with a position of human buttocks when sitting on said wheelchair; a foldable backrest disposed on a back frame which is connected to the chair frame; two wheels symmetrically arranged at lateral sides of the chair frame; two casters symmetrically arranged under a lower front of the chair frame; wherein the opening hole is arranged in an U shape; a separation gap is arranged along a middle line of the seat, allowing the seat to be symmetrically folded into an inverted V shape; and a removable seat pad is disposed on the opening hole for coverage when there is no need for excretion; a foldable supporting device disposed on the chair frame below the seat, including: a pair of lateral bars disposed above the cross members and parallel mounted on a pair of supporting base correspondingly arranged on the chair frame, said lateral bars connected to the cross brace for operation; a front section and a rear section, both disposed perpendicularly to the pair of lateral bars at a front end and a rear end of the lateral bars respectively, said front section and rear section each having a first connecting bar pivotally connected to a second connecting bar and a hollow hinge formed at an pivotal connected end thereof, another end of said first and second connecting bars individually engaged with a sleeve tube engaging through said lateral bars for folding operation, said hollow hinge enabling said first and second connecting bars to be folded in an inverted V shape; each of said front and rear sections further having a first bracket and a second bracket arranged correspondingly under a bottom surface thereof; a tub disposed below said seat under said opening hole as both substantially wider sides thereof extending out and forming a peripheral flange for engaging said first and second brackets respectively and taking the wastes of excretion; a wash device disposed at a side of said chair frame with a sprayer disposed at said hollow hinge of said rear section, facing toward said opening hole, said wash device including a water container detachably attached on said chair frame, a lotion pump disposed on said water container, a connector arranged at ax exit of said water container for connecting a water tube, said water tube further connecting to said sprayer for the water in said water container to be sent to said sprayer when said lotion pump is pressed downwards; and a wipe device including a handle, a first rod extended forwardly from an upper surface of said handle, a clip arranged at a front end of said first rod, a second rod extended forwardly from a lower surface of said handle and parallel with said first rod, said second rod having a free end penetrating through said hollow hinge of said front section, thereby having said first rod and said clip positioned above said supporting device, enabling said second rod to be linearly displaced back and forth through said hollow hinge of said front section and enabling said clip to carry a piece of toilet paper for wiping along with displacement of said second rod.

Furthermore, each of the armrests includes a bar section bending forwardly with a rear end thereof having a pivot section pivotally engaged a corresponding side of the back frame and a front end thereof forming a first engaging section to be engaged with a second engaging section arranged on a lateral side of the chair frame corresponding to the first engaging section, a locking section further disposed around the corresponding second engaging section so that when the first and second engaging sections are engaged, the corresponding locking section can lock and fix the engaging sections, and a stopping rod disposed at a side of said corresponding armrest above said corresponding pivot section for stopping said corresponding armrest when said corresponding locking section is loosened and said corresponding armrest is lifted upwards by said corresponding pivot section.

The connecter further includes a first connecting sheath with a rear end thereof engaged with the exit of the water container, a front end thereof extended to form a first connecting tube and a lateral side thereof forming a L-shaped hook, and a second connecting sheath with a positioning block arranged on a periphery thereof corresponding to a position of said L-shaped hook, thereby when the second connecting sheath is engaged with the first connecting tube, the second connecting sheath is further rotated for engaging the positioning block into the L-shaped hook, said second connecting sheath having a front end thereof extended to form a first connecting end for connection to the water tube.

In addition, a hanger is disposed at a side of the chair frame, and the hanger includes at least one hook and a pair of hanging section.

With structures disclosed above, the present invention has common functions as normal wheelchairs of being portable and foldable; additionally, it allows its users to perform excretion directly thereon and has a wash device for further cleansing. The design is therefore convenient for reducing burdens for caregivers and avoiding embarrassing situations for the users.

### BRIEF DESCRIPTION OF THE DRAWINGS

FIG. 1 is a perspective view of a conventional wheelchair;

FIG. 2A is an exploded view of a conventional foldable wheelchair with designs for excretion thereon;

FIG. 2B is a perspective view of the foldable wheelchair in FIG. 2A;

FIG. 3A is an exploded view of the present invention in a preferred embodiment;

FIG. 3B is a partially enlarged view of main structure of FIG. 3A;

FIG. 4 is a perspective view of the present invention in a preferred embodiment, illustrating a tub thereof detached from a chair frame thereof;

FIG. 5 is a perspective view of the present invention in a preferred embodiment, illustrating the tub disposed under the chair frame;

FIG. 6 is a perspective view of the present invention in a preferred embodiment, illustrating a seat thereof disposed in an opening hole thereof;

FIG. 7 is a perspective view of the present invention in a preferred embodiment, illustrating the seat removed from the opening hole and disposed aside the chair frame;

FIG. 8 is a top plan view of the present invention in a preferred embodiment;

FIG. 9 is an enlarged view of main structure of FIG. 8, illustrating a sprayer thereof engaged with a hollow hinge thereof;

FIG. 10 is a partial perspective view of a wash device thereof;

FIG. 11 is an exploded view of a connector of the wash device of FIG. 10;

FIG. 12A is an exploded view of a wipe device of the present invention;

FIG. 12B is a perspective view of the present invention illustrating the wipe device installed on the present invention;

FIG. 12C is a practical application view of the wipe device;

FIG. 13 is a schematic diagram showing an armrest of the present invention being lifted upwards; and

FIG. 14 is a perspective view of the present invention folded.

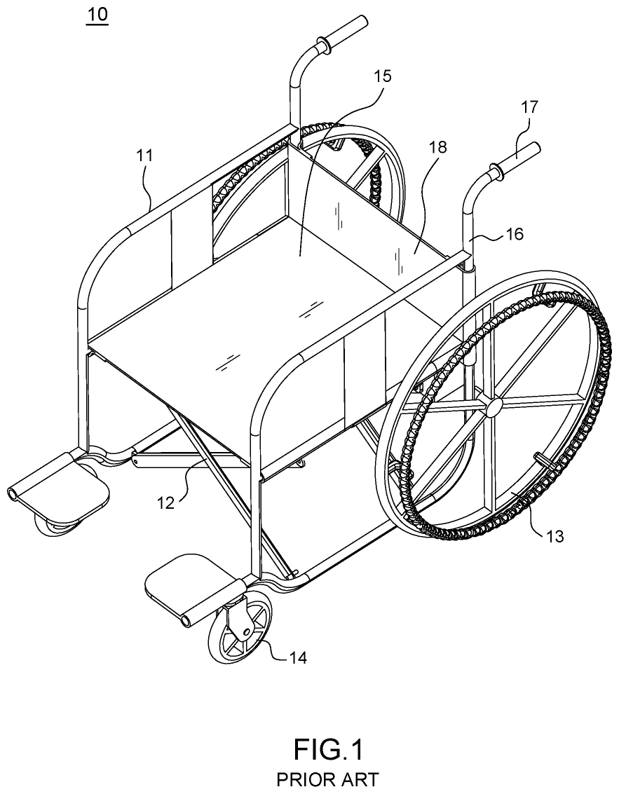

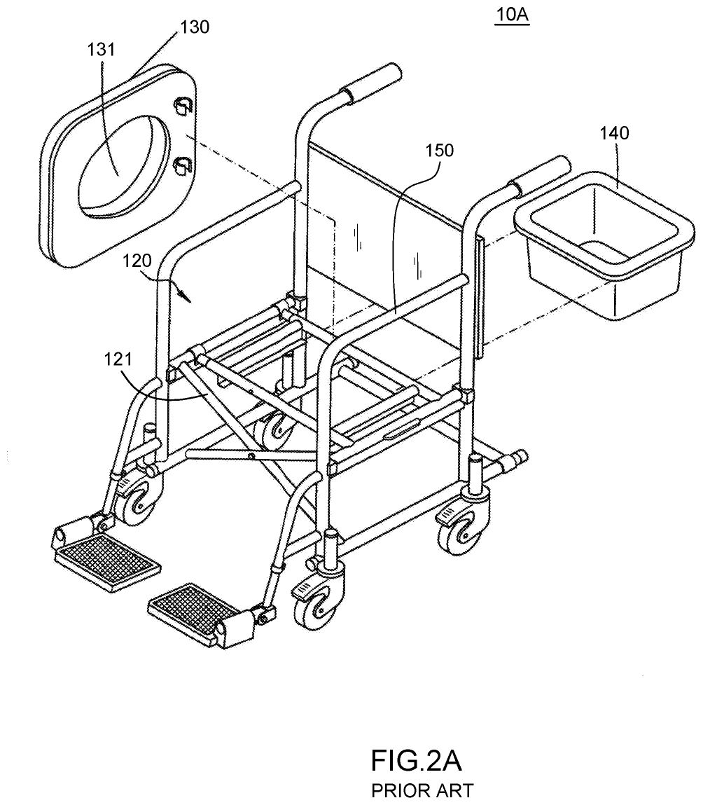

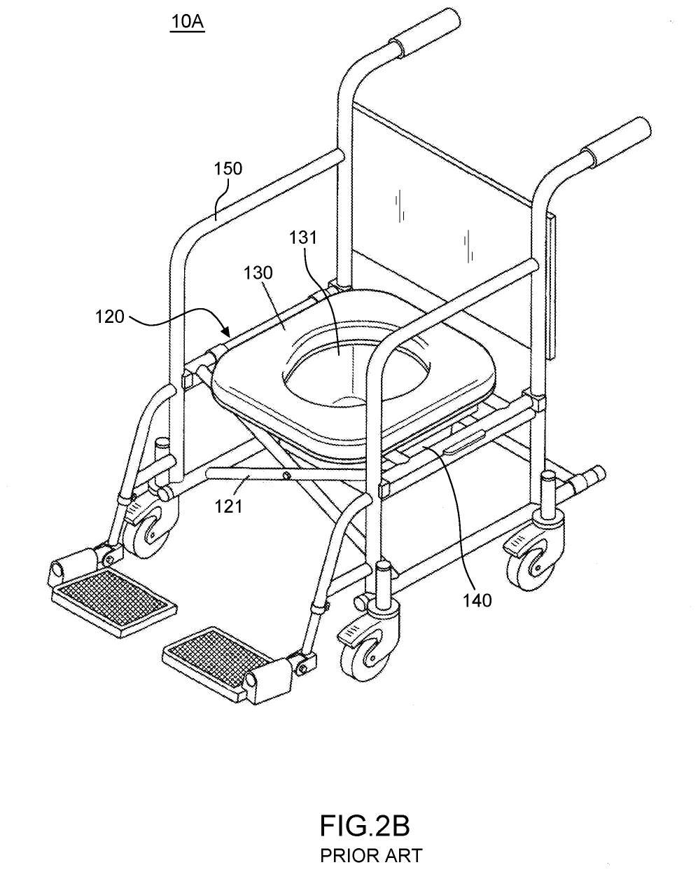

### DETAILED DESCRIPTION OF THE PREFERRED EMBODIMENT

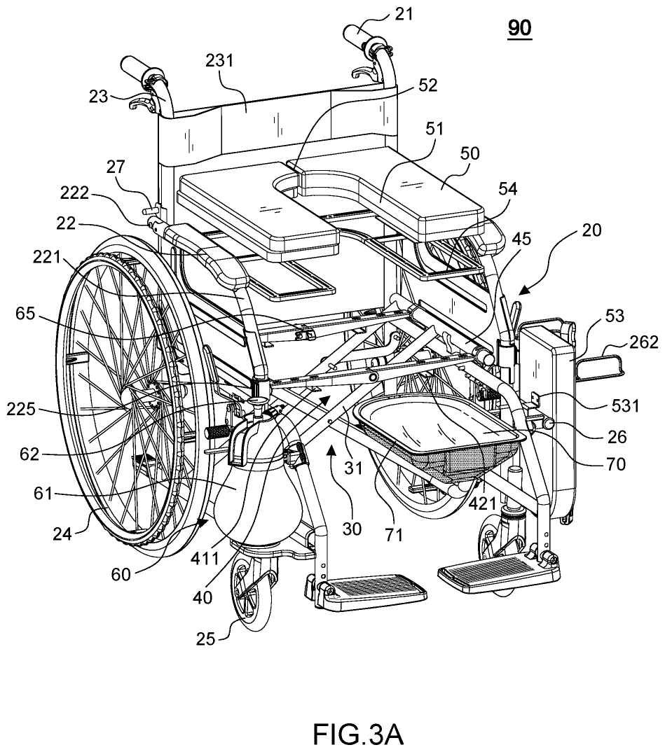

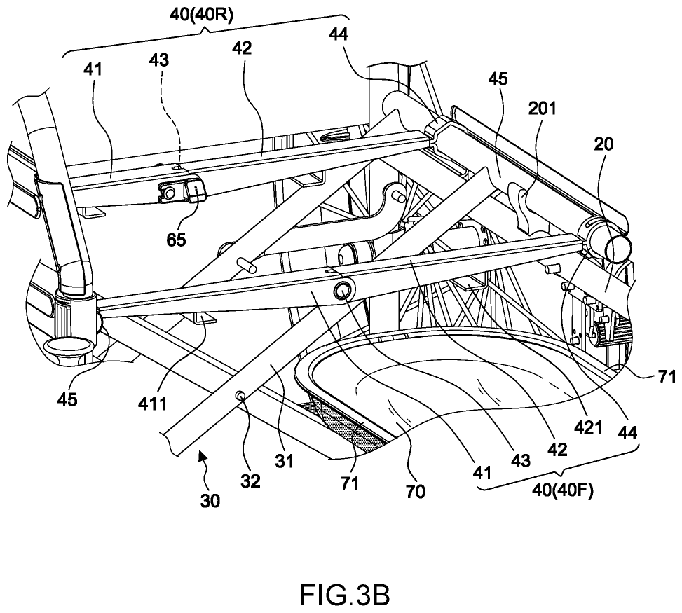

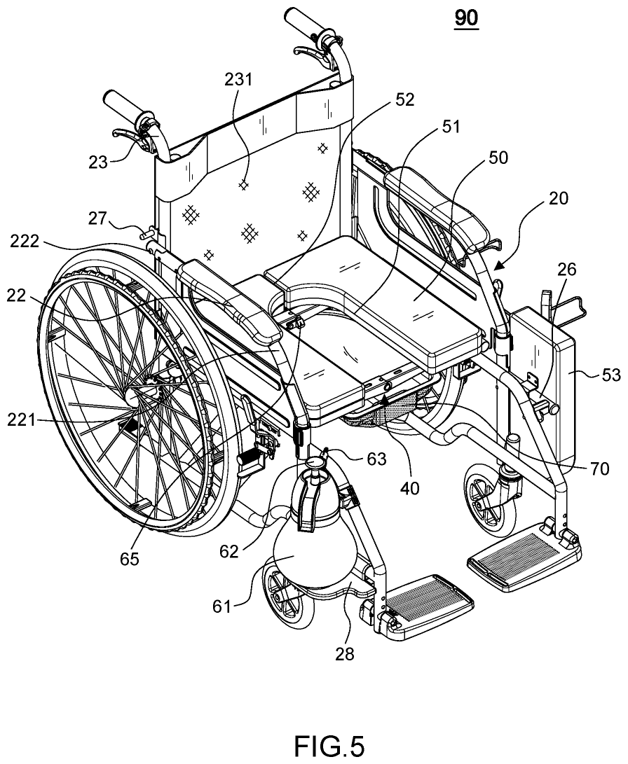

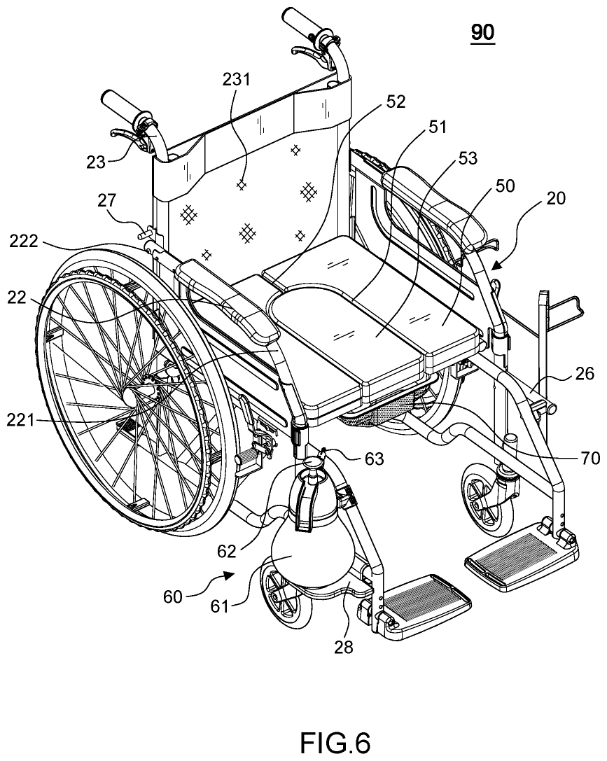

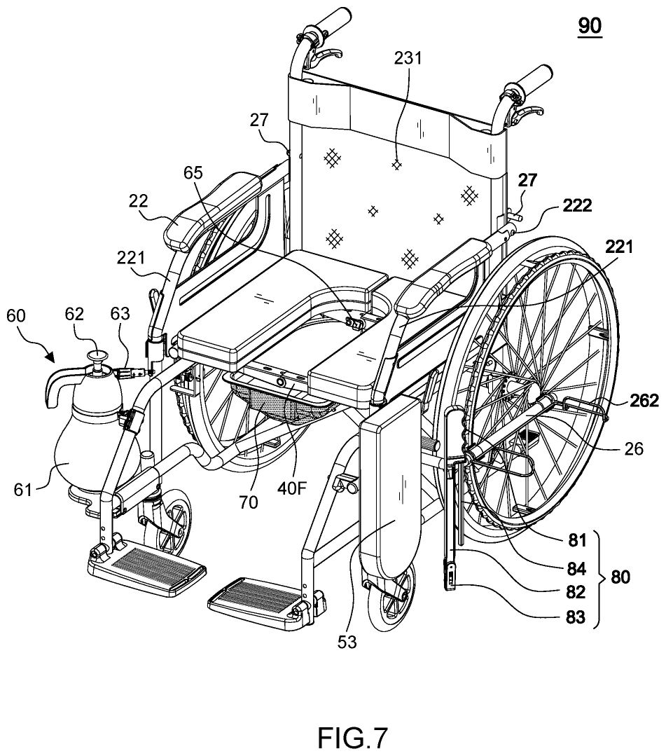

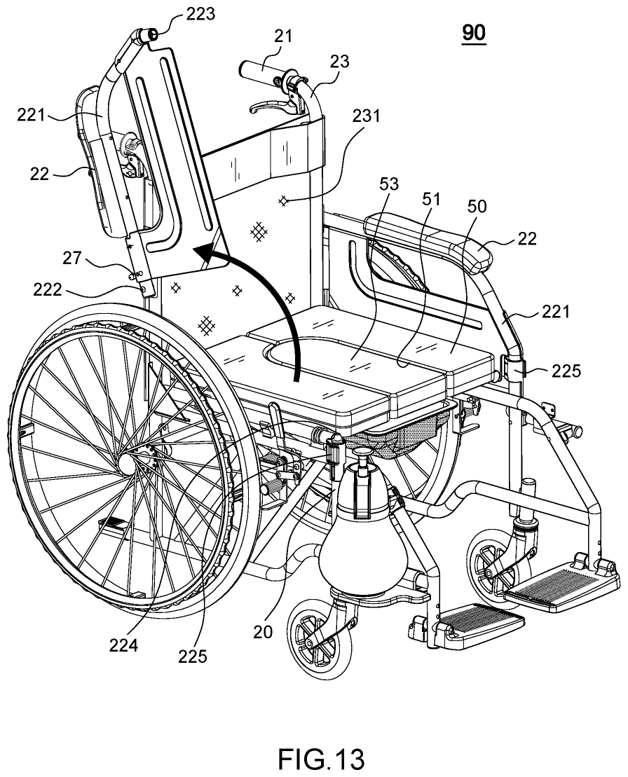

Referring to FIGS. 3-14, in a preferred embodiment, the present invention, a folding wheelchair with an excretion device 90, mainly includes a foldable chair frame 20, a cross brace 30, a foldable supporting device 40, a foldable seat 50, a foldable backrest 231, two wheels 24, two casters 25, a wash device 60, a tub 70 and a wipe device 80.

The chair frame 20 includes two push handles 21 symmetrically arranged at a rear thereof and two armrests 22 symmetrically arranged at lateral sides thereof. The cross brace 30 includes a plurality of crossed members 31 connected to the chair frame 20 for stable folding and unfolding by engaging with a pivot hinge 32 on the crossed members 31 as shown in FIG. 3B. The seat 50 is disposed in-between the chair frame 20 with an opening hole 51 arranged at a center thereof in accordance with a position of human buttocks when sitting on the wheelchair. The backrest 231 is disposed on a back frame 23 which is connected to the chair frame 20. The wheels 24 are symmetrically arranged at lateral sides of the chair frame 20. The casters 25 are symmetrically arranged under a lower front of the chair frame 20.

Such structure of a folding wheelchair is already commonly known in the prior art. The features of the present invention lies in that the opening hole 51 of the seat 50 is arranged in an U shape, that a separation gap 52 is arranged along a middle line of the seat 50, allowing the seat 50 to be symmetrically folded into an inverted V shape, and that a removable seat pad 53 is disposed on the opening hole 51 for coverage when there is no need for excretion. In this embodiment, a seat frame 54 is further disposed under the seat 50 for supporting as shown in FIG. 3A.

FIG. 3B is an enlarged perspective view of the main structure of FIG. 3A, illustrating the foldable supporting device 40 disposed on the chair frame 20 below the seat 50. The supporting device 40 includes a pair of lateral bars 45, a front section 40F and a rear section 40R.

The pair of lateral bars 45 are disposed above the cross members 31 and parallel mounted on a pair of supporting base 201 correspondingly arranged on the chair frame 20; the lateral bars 45 are thereby connected to the cross brace 30 for operation.

The front section 40F and rear section 40R are both disposed perpendicularly to the pair of lateral bars 45 at a front end and a rear end of the lateral bars 45 respectively. The front section 40F and rear section 40R each has a first connecting bar 41 pivotally connected to a second connecting bar 42 and a hollow hinge 43 formed at an pivotal connected end thereof; another end of the first and second connecting bars 41, 42 are individually engaged with a sleeve tube 44 engaging through the lateral bars 45 for folding operation. The hollow hinge 43 enables the first and second connecting bars 41, 42 to be folded in an inverted V shape, and each of the front and rear sections 40F, 40R further has a first bracket 411 and a second bracket 421 arranged correspondingly under a bottom surface thereof. The tub 70 is disposed below the seat 50 under the opening hole 51 as both substantially wider sides thereof extending out and forming a peripheral flange 71 for engaging the first and second brackets 411, 421 respectively and taking the wastes of excretion.

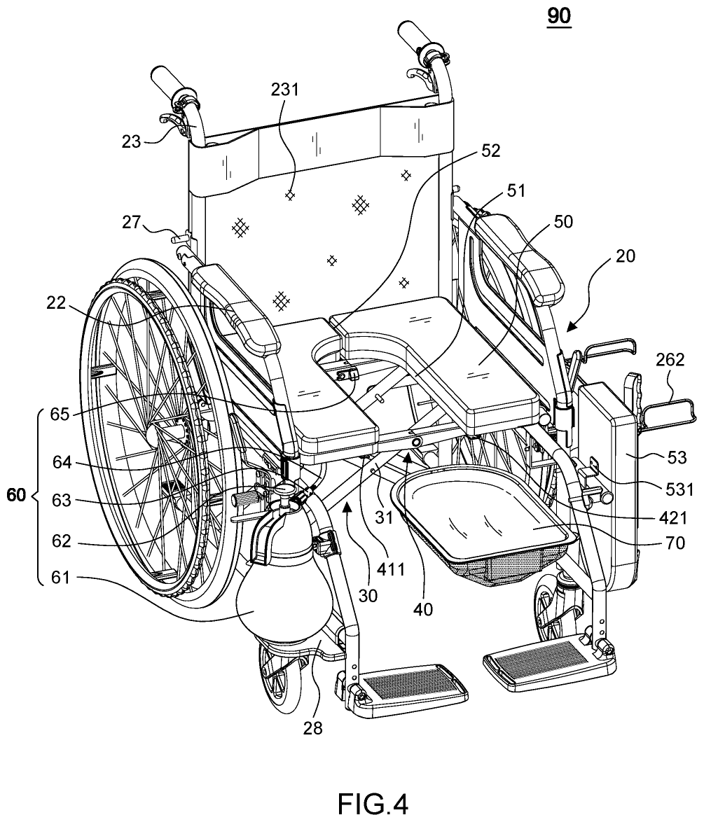

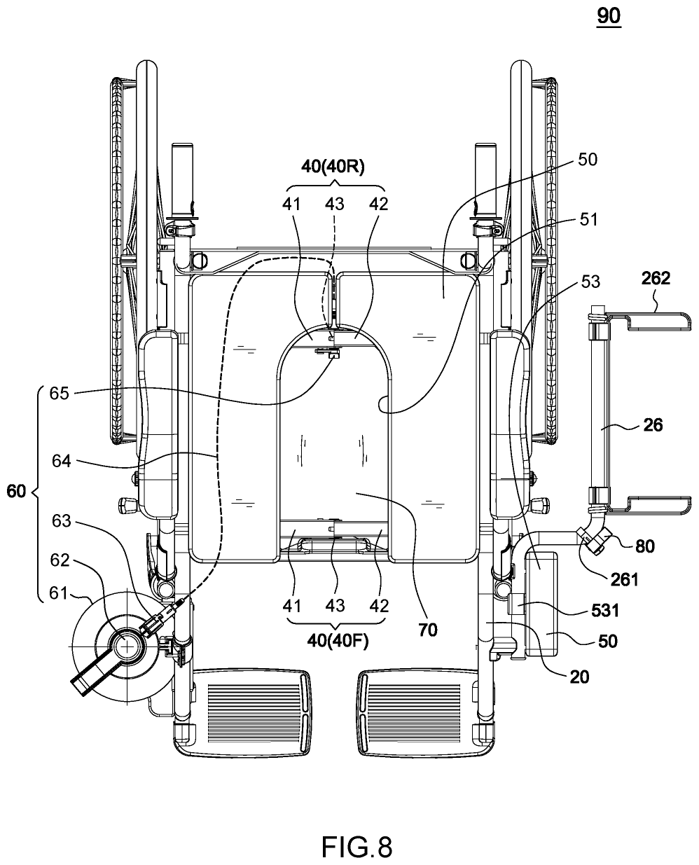

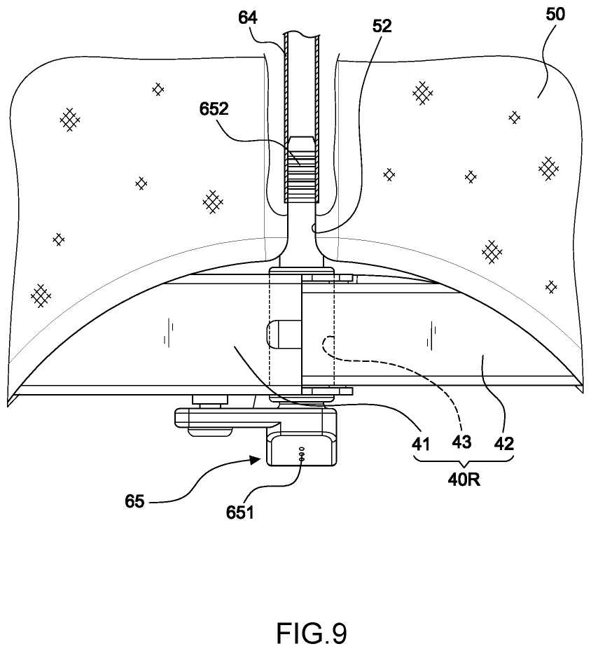

Referring to FIG. 4, the wash device 60 is disposed at a side of the chair frame 20 and mainly includes a sprayer 65 and a water container 61. The sprayer 65 is disposed at the hollow hinge 43 of the rear section 40R, facing toward the opening hole 51 of the seat 50, as shown in FIGS. 8 and 9. The water container 61 is detachably attached on the chair frame 20 with a lotion pump 62 disposed on the water container 61, and a connector 63 is engaged at ax exit 611 of the water container 61 for connecting a water tube 64; the water tube 64 is further connecting to a second connecting end 652 of the sprayer 65 for the water in the water container 61 to be sent to the sprayer 65 by the force of air pressure when the lotion pump 62 is pressed downwards. A plurality of exit hole 651 is further arranged on the sprayer 65 for the user to cleanse. In this embodiment, the water container 61 is disposed on a placing board 28 arranged at a side of the chair frame 20, and the water tube 64 goes under the seat 50 to the separation gap 52 and then is connected to the sprayer 65.

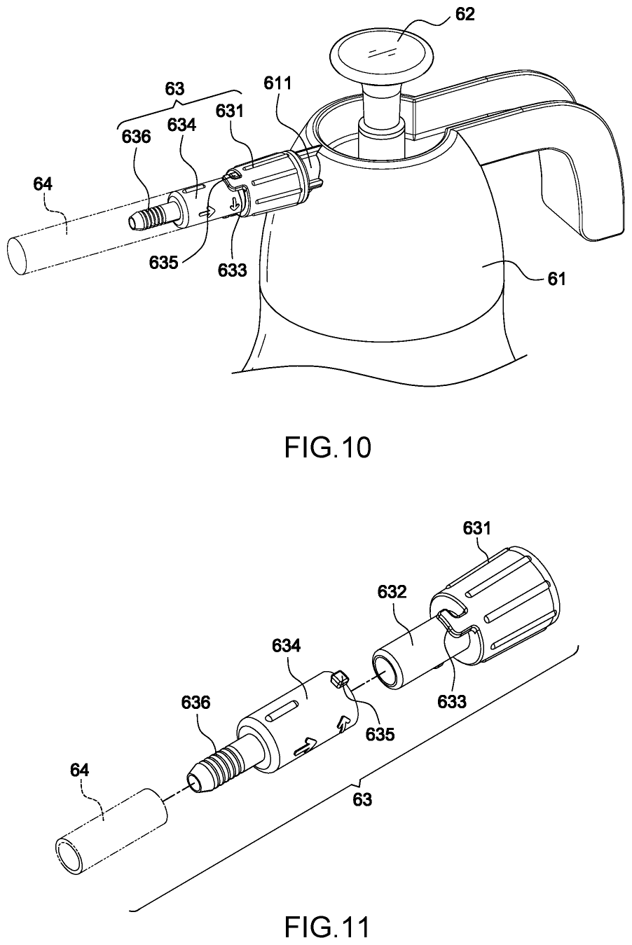

FIGS. 10 and 11 illustrated the structure of the wash device 60 and the connector 63. In this embodiment, the connector 63 has a first connecting sheath 631 with a rear end thereof engaged with the exit 611 of the water container 61, a front end thereof extended to form a first connecting tube 632 and a lateral side thereof forming a L-shaped hook 633, and a second connecting sheath 634 with a positioning block 635 arranged on a periphery thereof corresponding to a position of the L-shaped hook 633. When the second connecting sheath 634 is engaged with the first connecting tube 632, the second connecting sheath 634 is further rotated for engaging the positioning block 635 into the L-shaped hook 633; the second connecting sheath 634 has a front end thereof extended to form a first connecting end 636 for connection to the water tube 64.

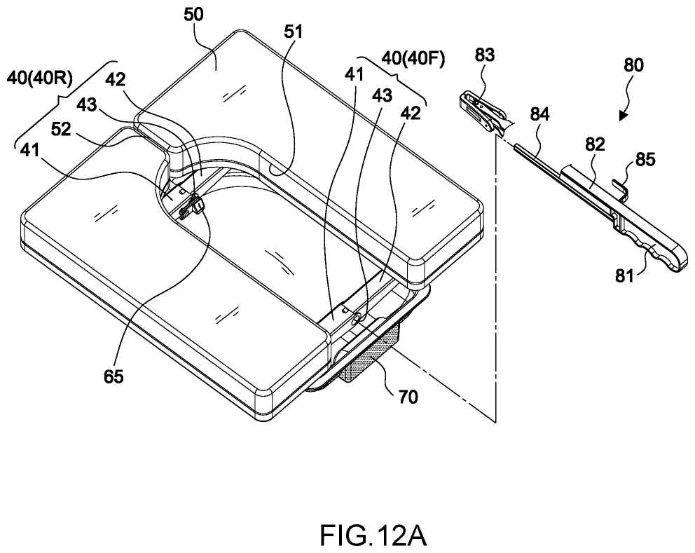

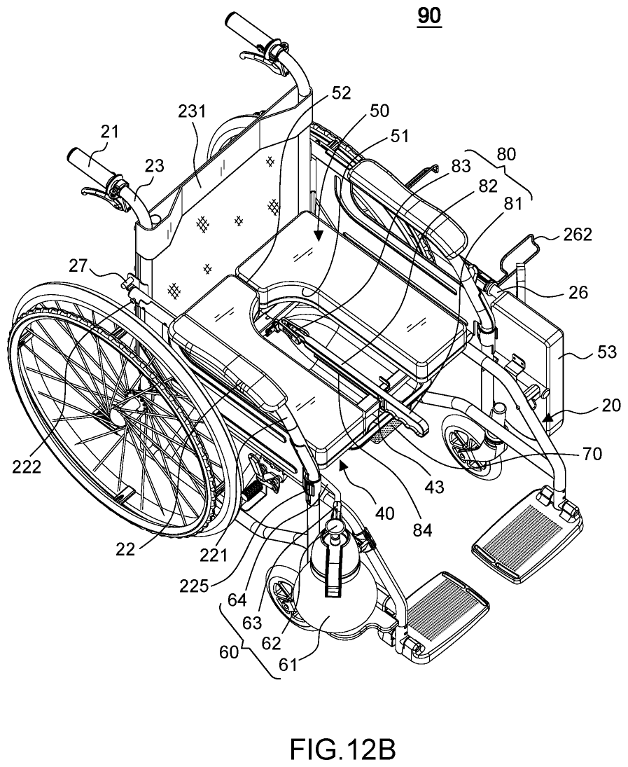

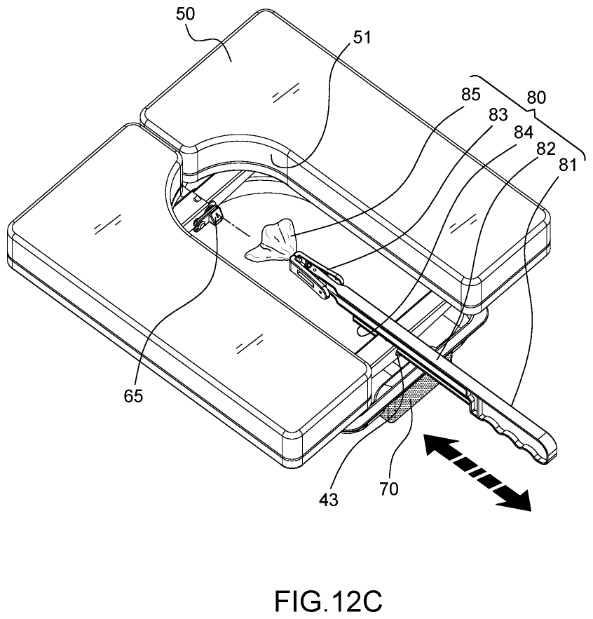

Further referring to FIGS. 12A and 12B, the wipe device 80 includes a handle 81, a first rod 82, a clip 83 and a second rod 84. The first rod 82 is extended forwardly from an upper surface of the handle 81. The clip 83 is arranged at a front end of the first rod 82. The second rod 84 is extended forwardly from a lower surface of the handle 81 and parallel with the first rod 82. The second rod 84 further has a free end penetrating through the hollow hinge 43 of the front section 40F, thereby the first rod 82 and the clip 83 are positioned above the supporting device 40, enabling the second rod 84 to be linearly displaced back and forth through the hollow hinge 43 of the front section 40F and enabling the clip 83 to carry a piece of toilet paper for wiping along with displacement of the second rod 84 as shown in FIG. 12C.

In this embodiment, each of the armrests 22 further includes a bar section 221 bending forwardly with a rear end thereof having a pivot section 222 pivotally engaged a corresponding side of the back frame 20 and a front end thereof forming a first engaging section 223. Both of the first engaging section 223 are further engaged with a corresponding second engaging section 224 arranged on a lateral side of the chair frame 20. Each of the second engaging section 224 has a locking section 225 disposed around so that when the first and second engaging sections 223, 224 are engaged, the corresponding locking section 225 can lock and fix the engaging sections 223, 224. Each of the corresponding armrest 22 further has a stopping rod 27 disposed at a side thereof above the corresponding pivot section 222 for stopping the corresponding armrest 22 when the corresponding locking section 225 is loosened and the corresponding armrest 22 is lifted upwards by the corresponding pivot section 222. Such design increases the conveniences for the users to sit on or get up from the folding wheelchair 90.

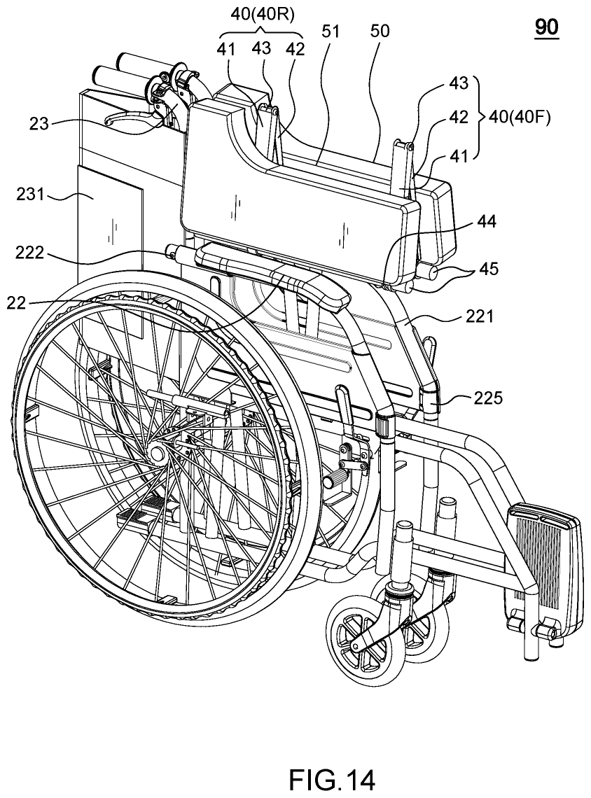

In this embodiment, a hanger 26 is disposed at a side of the chair frame 20 and includes at least one hook 261 and a pair of hanging section 262. With reference to FIGS. 3A, 7 and 8, the seat pad 53 is hung on the hanger 26 by a small hook 531 and the wipe device 80 can be hung on the hook 261. The hanging sections 262 can be further used for hanging towels or clothes (not shown). In addition, the folding wheelchair 90 can be folded for easier carrying as shown in FIG. 14.

All in all, structures of the supporting device 40, the wash device 60 and the wipe device 80 are integrated into the original design of a folding wheelchair to keep the common functions of a normal wheelchair and include extra functions for its users to excrete right on the wheelchair and to conveniently operate washing and wiping for cleansing after excretion. The present invention therefore reduces burdens for both the users and caregivers and saves them from embarrassing situations that they may encounter in daily life.

What is claimed is:

1. A folding wheelchair with an excretion device, comprising:
a foldable chair frame including two push handles symmetrically arranged at a rear thereof and two armrests symmetrically arranged at lateral sides thereof;
a cross brace including a plurality of crossed members connected to the chair frame for stable folding and unfolding;
a foldable seat disposed in-between the chair frame with an opening hole arranged at a center thereof in accordance with a position of human buttocks when sitting on said wheelchair;
a foldable backrest disposed on a back frame which is connected to the chair frame;
two wheels symmetrically arranged at lateral sides of the chair frame;
two casters symmetrically arranged under a lower front of the chair frame;
wherein the opening hole is arranged in an U shape; a separation gap is arranged along a middle line of the seat, allowing the seat to be symmetrically folded into an inverted V shape; and a removable seat pad is disposed on the opening hole for coverage when there is no need for excretion;
a foldable supporting device disposed on the chair frame below the seat, including:
a pair of lateral bars disposed above the cross members and parallel mounted on a pair of supporting base correspondingly arranged on the chair frame, said lateral bars connected to the cross brace for operation; and
a front section and a rear section, both disposed perpendicularly to the pair of lateral bars at a front end and a rear end of the lateral bars respectively, said front section and rear section each having a first connecting bar pivotally connected to a second connecting bar and a hollow hinge formed at an pivotal connected end thereof, another end of said first and second connecting bars individually engaged with a sleeve tube engaging through said lateral bars for folding operation, said hollow hinge enabling said first and second connecting bars to be folded in an inverted V shape; each of said front and rear sections further having a first bracket and a second bracket arranged correspondingly under a bottom surface thereof;
a tub disposed below said seat under said opening hole as both substantially wider sides thereof extending out and forming a peripheral flange for engaging said first and second brackets respectively and taking the wastes of excretion;
a wash device disposed at a side of said chair frame with a sprayer disposed at said hollow hinge of said rear section, facing toward said opening hole, said wash device including a water container detachably attached on said chair frame, a lotion pump disposed on said water container, a connector arranged at ax exit of said water container for connecting a water tube, said water tube further connecting to said sprayer for the water in said water container to be sent to said sprayer when said lotion pump is pressed downwards; and
a wipe device including a handle, a first rod extended forwardly from an upper surface of said handle, a clip arranged at a front end of said first rod, a second rod extended forwardly from a lower surface of said handle and parallel with said first rod, said second rod having a free end penetrating through said hollow hinge of said front section, thereby having said first rod and said clip positioned above said supporting device, enabling said second rod to be linearly displaced back and forth through said hollow hinge of said front section and enabling said clip to carry a piece of toilet paper for wiping along with displacement of said second rod.

2. The folding wheelchair with an excretion device as claimed in claim 1, wherein each of the armrests further includes a bar section bending forwardly with a rear end thereof having a pivot section pivotally engaged a corresponding side of the back frame and a front end thereof forming a first engaging section to be engaged with a second engaging section arranged on a lateral side of the chair frame corresponding to the first engaging section, a locking section further disposed around the corresponding second engaging section so that when the first and second engaging sections are engaged, the corresponding locking section can lock and fix the engaging sections, and a stopping rod disposed at a side of said corresponding armrest above said corresponding pivot section for stopping said corresponding armrest when said corresponding locking section is loosened and said corresponding armrest is lifted upwards by said corresponding pivot section.

3. The folding wheelchair with an excretion device as claimed in claim 1, wherein the connecter further includes a first connecting sheath with a rear end thereof engaged with the exit of the water container, a front end thereof extended to form a first connecting tube and a lateral side thereof forming a L-shaped hook, and a second connecting sheath with a positioning block arranged on a periphery thereof corresponding to a position of said L-shaped hook, thereby when the second connecting sheath is engaged with the first connecting tube, the second connecting sheath is further rotated for engaging the positioning block into the L-shaped hook, said second connecting sheath having a front end thereof extended to form a first connecting end for connection to the water tube.

4. The folding wheelchair with an excretion device as claimed in claim 1, wherein a hanger is disposed at a side of the chair frame, said hanger including at least one hook and a pair of hanging section.
